(19) United States
(12) Patent Application Publication
(10) Pub. No.: US 2003/0188470 A1
(43) Pub. Date: Oct. 9, 2003

(54) Aligning product packages displayed on a scanning hook

(76) Inventor: Carl A. Valiulis, Rockford, IL (US)

Correspondence Address: LAWRENCE E. CROWE, 308 NORTH WALNUT STREET, LINDENWOOD, IL, 61049, US

(21) Appl. No.: 10/407,588

(22) Filed: Apr. 5, 2003

Related U.S. Application Data
(60) Provisional application No. 60/370,756, filed on Apr. 6, 2002.

(51) Int. Cl. G09F 3/00

(52) U.S. Cl. 40/642.01

(57) ABSTRACT

An apparatus and method for aligning product packages on a scanning hook, is provided through utilization of product facing device adapted to be mounted on the upper arm of the scanning hook for sliding movement there along and adapted to be gripped adjacent the outer distal end of the upper arm regardless of the position of the facing device along the upper arm, for facing product packages supported on the lower arm of the scanning hook. The facing device includes a forked element extending downward from the upper arm past the lower arm of a scanning hook, and an elongated pulling member extending along the upper arm of the scanning hook from the forked element forward to the outer distal end of the upper arm, where the pulling member terminates in a grip element that may also be a label holder.

### PRIORITY CLAIM

This application claims the benefit of the U.S. Provisional Patent Application bearing the serial No. 60/370,756, filed Apr. 6, 2002, titled ALIGNING PRODUCT PACKAGES DISPLAYED ON A SCANNING HOOK, by Carl A. Valiulis.

### TECHNICAL FIELD OF THE INVENTION

This invention relates to displaying product packages on hooks extending from a panel, and more particularly to aligning such product packages in a uniformly facing manner providing a neat and attractive presentation of the displayed product, with the product packages aligned toward the distal end of the hook to facilitate removal of the packages from the hook.

### BACKGROUND OF THE INVENTION

In modern retail merchandising, products are often displayed in packages adapted to hang from a wire hook extending from a panel. A large retail store may have thousands of such hooks, mounted on panels attached to the walls of the store, and/or free-standing fixtures such as racks or gondolas on the floor of counters of the store. Each hook may have the capacity for supporting a number of packages along its length, to maintain a continuous supply of product packages for removal by consumers, with periodic re-stocking of the packages onto the hooks.

It is desirable that the product packages on the hooks be displayed at all times in a neatly aligned fashion, with the packages uniformly aligned toward the outer end of the hook where they can be readily reached and removed by a consumer, Such a neat display is pleasing and attractive to the consumer, and promotes sales by making the product readily visible.

In addition to making the product packages clearly visible and convenient to the consumer, it is both desirable and often necessary for inventory control purposes, that each hook include a provision for attaching a label to the hook with the price and Uniform Product Code (UPC) displayed on the label. As part of controlling inventory and re-stocking activities in large stores, an employee travels down the aisles of the store with a hand-held scanner, and scans a bar code indicating the UPC on each label. The employee counts the number of packages remaining on each hook and enters that number into the scanning device. The scanning device transmits the UPC code and number remaining to a central inventory control system, that in turn issues orders for more product and re-stocking instructions. For large stores, having hundreds or thousands of hooks, the employee may also enter or automatically scan a code on the label indicating the location of the hook in the store.

It is also necessary that a product display device, meeting the requirements discussed above, be producible at a very low cost of only a few cents each, and be rugged and reliable enough for use.

Through the years, retailers and manufacturers of product display hooks have developed a variety of devices that meet some, but not all of the requirements defined above. One of the most commonly utilized devices is known as a “scanning hook.” As shown in FIG. 1, a scanning hook includes a U-shaped hook 10, generally made of round metal wire, having a lower arm 12 for suspending product packages 14, and an upper arm 16 adapted at the outer, or distal, end 18 thereof for attaching a label holder 20. A U-shaped portion 22 of the scanning hook 10, joining the upper and lower arms 16, 12, is adapted for attachment to a mounting bracket 24, sometimes known as a “back,” used for attaching the scanning hook 10 to a panel 26. The mounting bracket 24 and/or the label holder 20 may be separable, as shown in FIG. 1, or alternatively integrally joined the hook 10.

In some cases, an inventory control device, as illustrated by U.S. Pat. No. 4,869,376 is used for positioning product packages on a display hook. The inventory control device of the '376 patent is a piece of wire forms a bridge portion with an open hook at one end and a closed eye at the other end. The inventory control device is installed, by slipping the eye of the inventory control device onto one arm of the display hook, and by hooking the open hook of the inventory control device around the other arm of the display hook. The inventory control device is manually moved along the arms of the display hook, behind the product packages, for holding inventory near the forward end of the display hook. To move the inventory control device, however, one must reach back along the display hook, past any product packages remaining on the display hook, to grasp the inventory control device of the '376 patent and pull it forward. The inventory control device of the '376 patent is difficult to grasp and manipulate in a crowded display gondola, and does not provide a mechanism for facing the product packages in a uniform alignment, oriented generally perpendicular to the display hook. Where the packages are suspended from the hook by C-shaped hangers, for facilitating hanging the packages on the display hook, it is also difficult to use the device of the '376 patent without knocking product packages off of the display hook while trying to reach around the packages to grasp and manipulate the device.

What is needed, therefore, is an improved device and method, solving one or more of the problems described above, for aligning product packages on a U-shaped scanning hook, in a uniformly facing manner providing a neat and attractive presentation of the displayed product, with the product packages aligned toward the distal end of the hook to facilitate removal of the packages from the hook. It is further desirable that the improved device and method be adaptable to existing scanning hooks.

### SUMMARY OF THE INVENTION

My invention provides an improved device and method for aligning product packages on a scanning hook, in a uniformly facing manner providing a neat and attractive presentation of the displayed product, with the product packages aligned toward the distal end of the lower arm of the hook to facilitate removal of the packages from the hook, through utilization of product facing device, adapted to be slidably mounted on the upper arm of the scanning hook for sliding movement there along, and also adapted to be gripped adjacent the outer distal end of the upper arm regardless of the position of the facing device along the upper arm, for facing product packages supported on the lower arm of the scanning hook.

In one form of my invention, a facing device includes a forked element extending downward from the upper arm past the lower arm of a scanning hook, and an elongated pulling member extending along the upper arm of the scanning hook from the forked element forward to the outer distal end of the upper arm, where the pulling member terminates in a grip element. The grip element may be a label holder.

The forked element is positioned at the rear of the upper arm, as product packages are placed onto the lower arm of the scanning hook. During normal display straightening or inventory activities, product packages remaining on the lower arm can be quickly and conveniently faced, by grasping the grip element of the facing device, and pulling the packages forward. As the facing device is pulled forward, the forked element will move the packages toward the outer end of the lower arm, and align them in a uniformly forward facing direction, by virtue of its forked shape. The facing device is then returned to its initial stowed position with the forked element positioned at the rear of the upper arm, and the grip element positioned adjacent the outer distal end of the upper arm.

The various aspects of my invention may take a number of forms, such as a facing device for attachment to a scanning hook, a scanning hook having a facing device attached to the scanning hook, or a method aligning product packages on a scanning hook. The foregoing and other features and advantages of the invention are apparent from the following detailed description of exemplary embodiments, read in conjunction with the accompanying drawings. The detailed description and drawings are merely illustrative of the invention rather than limiting.

### DESCRIPTION OF DRAWINGS

FIG. 1 is an isometric depiction of a prior U-shaped scanning hook, with a removable label holder and mounting bracket, adapted for attachment to a panel;

FIGS. 2a-e are perspective views of a first embodiment of my invention, in the form of a display apparatus having a facing device adapted for sliding attachment to the upper arm of a scanning hook of the type depicted in FIG. 1;

FIGS. 3a-d are perspective and orthographic views of a second embodiment of my invention, in the form of a second embodiment of a facing device having a facing device integrally attached;

FIG. 4 is a perspective exploded view of an embodiment of the display apparatus of FIGS. 2a-e, further including a return element adapted for attachment between the facing device and the scanning hook, and providing a force for returning the facing device to an initial stowed position along the upper arm of the scanning hook;

FIG. 5 is a partial cross-sectional view of an embodiment of the display apparatus of FIGS. 3a-d, further including a return element operatively attached between the facing device and the scanning hook, and providing a force for returning the facing device to an initial stowed position along the upper arm of the scanning hook.

### DETAILED DESCRIPTION OF EXEMPLARY EMBODIMENTS

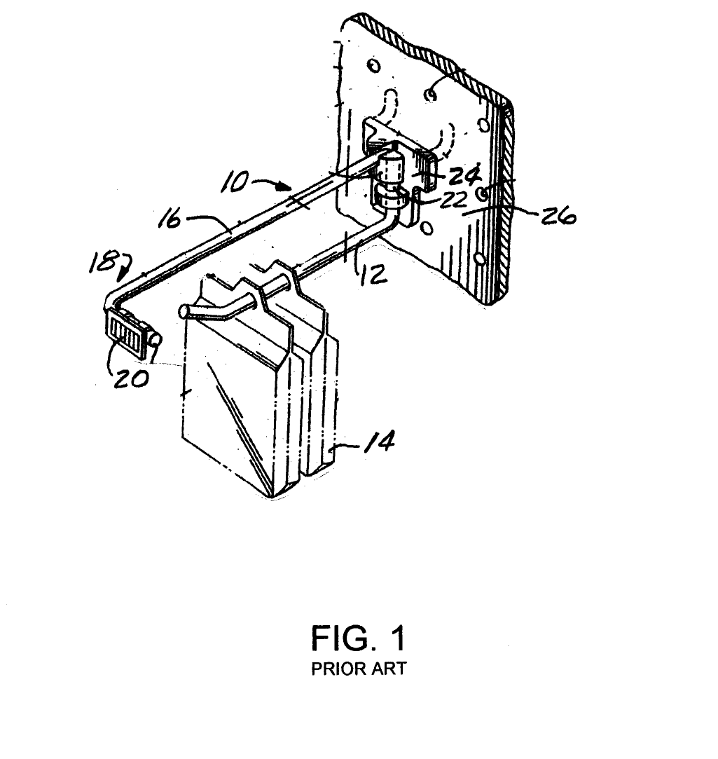

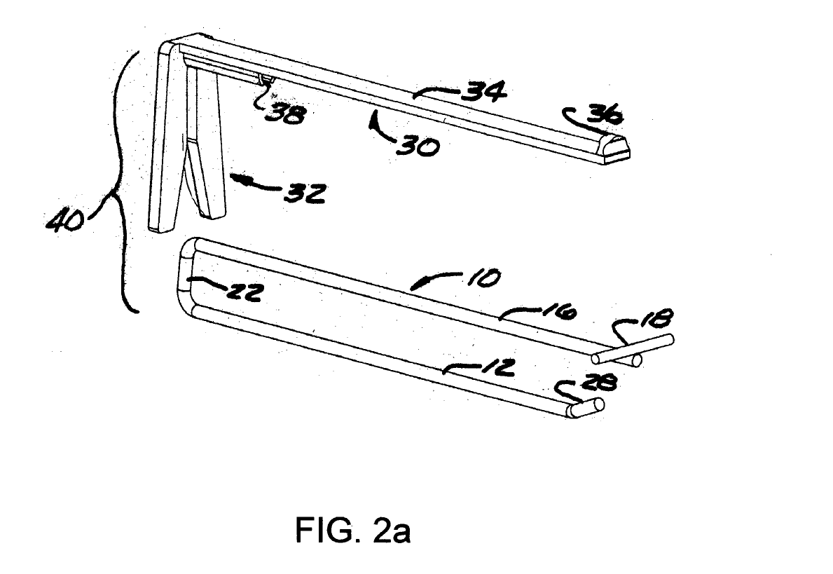

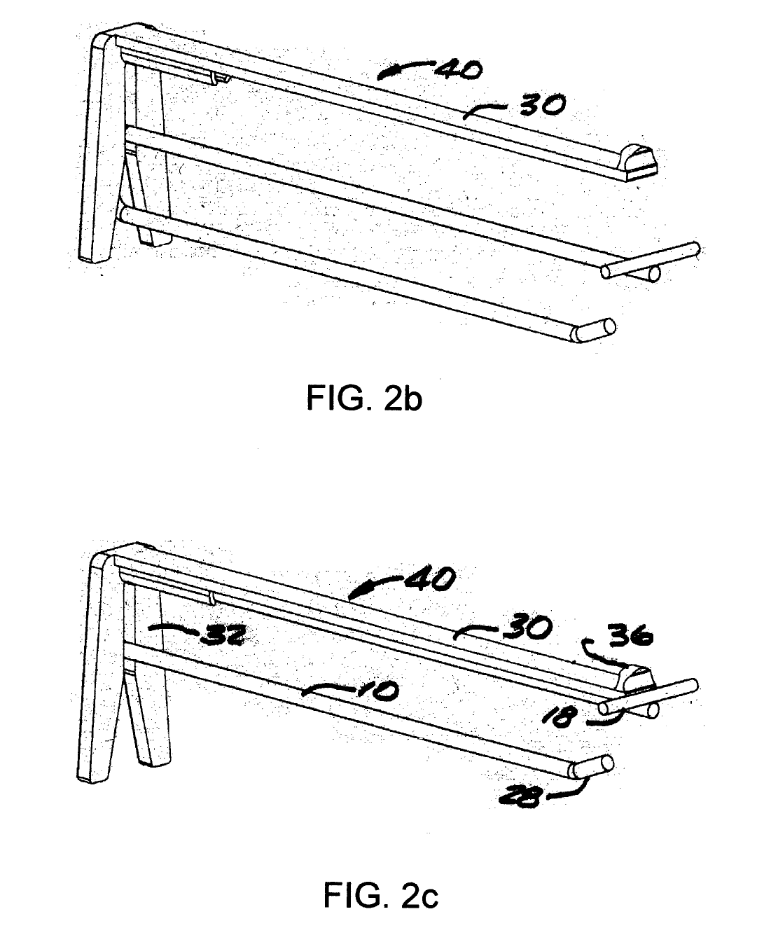

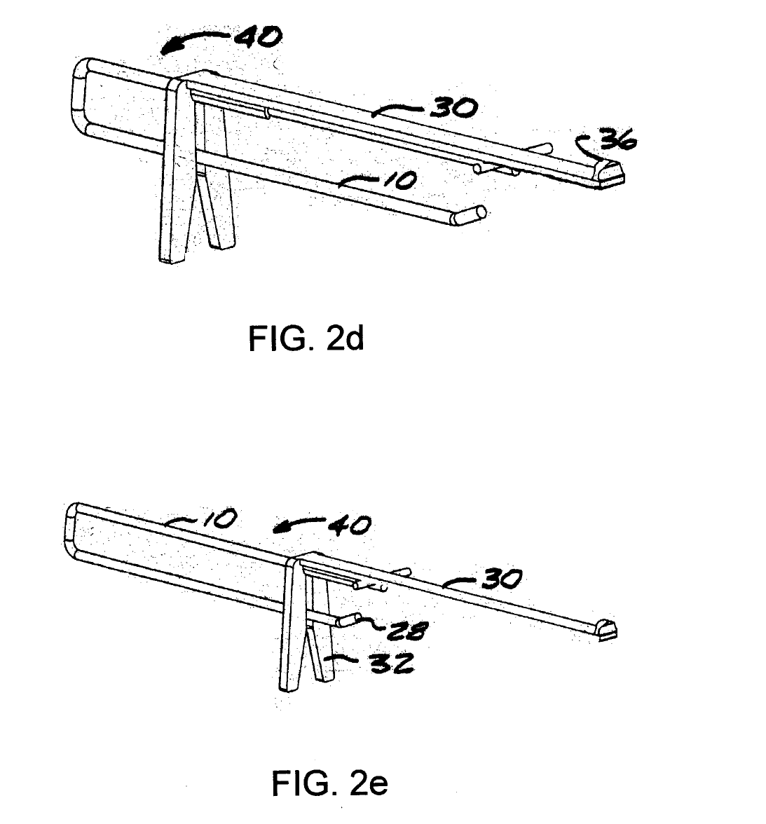

FIGS. 2a-e, show a first exemplary embodiment of display apparatus 40, including a scanning hook 10, and facing device 30, according to my invention. For convenience of explanation, the reference numbers used with regard to the scanning hook 10 are the same as those used in describing the prior art hook depicted in FIG. 1. It is understood, however, that the scanning hook 10 of my invention may or may not be the same as the scanning hook 10 depicted in FIG. 1.

The facing device 30 includes a forked element 32 adapted to extend downward from the upper arm 16 past the lower arm 12 of the scanning hook 10, and an elongated pulling member 34 extending along the upper arm 16 of the scanning hook 10 from the forked element 32 forward to the outer distal end 18 of the upper arm 16, where the pulling member 34 terminates in a grip element 36. A channel 38 extending downward from the underside of the pulling member 34 is adapted to snap over the upper arm 16 of the scanning hook 10, as sequentially shown in FIGS. 2b and 2c, for attaching the facing device 30 to the scanning hook 10. It is contemplated that the facing device may be manufactured from a plastic material that is resilient, to facilitate snapping the facing device 30 in place, and to minimize cost. Other materials can also be utilized, however.

In operation, the forked element 32 is positioned as shown in FIG. 2c, in a stowed position at the rear of the upper arm 16, adjacent the U-shaped portion 22 of the hook 10. The forked element 32 may be moved to the rear of the upper arm 16 before placing product packages on the lower arm 12, or gradually pushed back along the lower arm 12 by the rear surface of the rearmost package as additional product packages are sequentially placed onto the lower arm 12 of the scanning hook 10.

During normal display straightening or inventory activities, product packages remaining on the lower arm 12 can be quickly and conveniently faced, by grasping the grip element 36 of the facing device 30, and pulling the facing device 30 forward, as shown in FIGS. 2d and 2e. As the facing device 30 is pulled forward, the forked element 32 will move the packages toward the outer end 28 of the lower arm 12, and align them in a uniformly forward facing direction, by virtue of its forked shape. The facing device 30 is then returned to its initial stowed position, as shown in FIG. 2c, with the forked element 32 positioned at the rear of the upper arm 16, and the grip element 36 positioned adjacent the outer distal end 18 of the upper arm 16.

It will be appreciated that the facing device 30 may be utilized with scanning hooks 10 adapted for use with removable mounting brackets and/or label holders, and also with scanning hooks having integrally attached mounting brackets and/or label holders. The outer end 28 of the lower arm 12 may be upturned, as shown, or otherwise formed to retain the product packages on the lower arm 12 during the facing operation, until they are pulled off by a consumer.

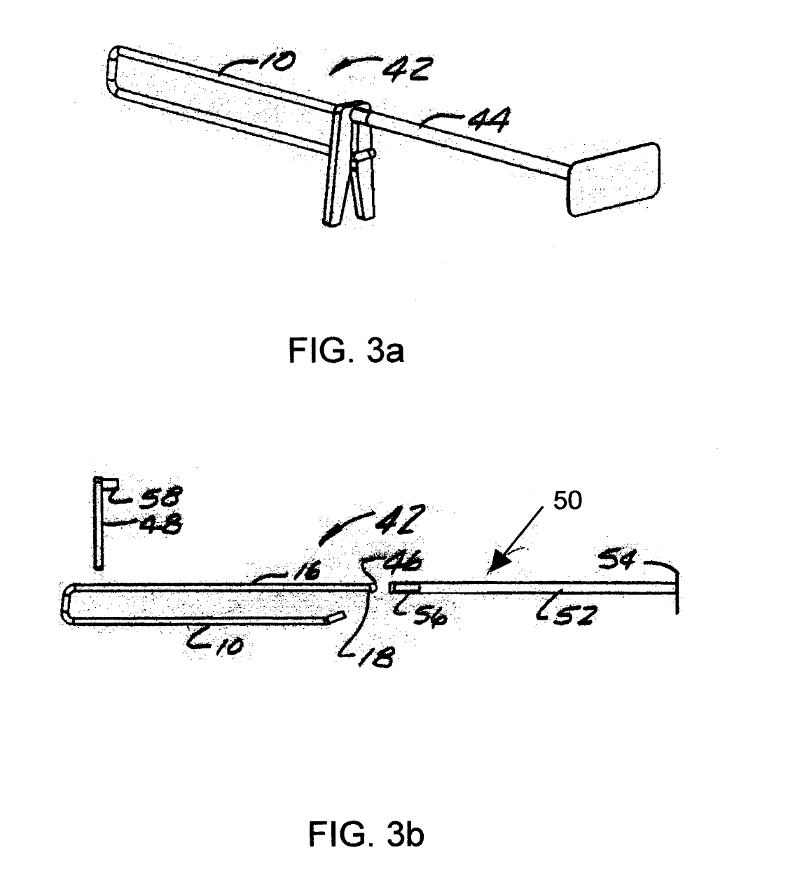

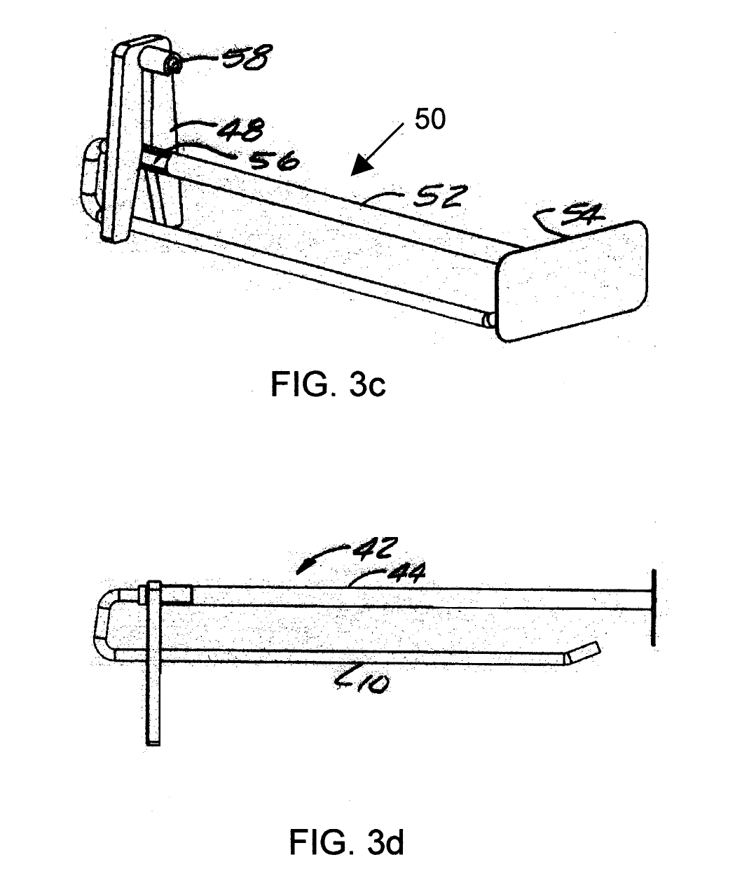

FIGS. 3a-d depict a second exemplary embodiment of a diplay apparatus 42 having a facing device 44 adapted for installation on a scanning hook 10 having an upper arm 16 of a first diameter, terminating at the distal end 18 thereof in a ball or head 46 having a second diameter larger than the first diameter of the upper arm 16.

The facing device 44 is formed of two pieces, a forked element 48, and a pulling element 50. The pulling element 50 includes an elongated tubular member 52, having an inside diameter larger than the diameter of the ball 46, such that the tubular element can slide over the ball 46 and upper arm 16 of the scanning hook 10. A label holder 54, integrally joined to the outer end of the tubular member 52, serves a dual function as the grip element of the facing device 44. The tubular member 52 also defines a pair of oppositely opening slots 56 adjacent the open end of the tubular member 52, for receipt of a locking channel portion 58 of the forked element 48. The locking channel portion 58 defines an inner diameter that is smaller than the diameter of the ball 46, but sufficiently larger than the diameter of the upper arm 16, such that once the locking channel portion 58 is snapped into place in the slots 56 of the tubular member around the upper arm 16, as shown sequentially in FIGS. 3b-d, the tubular member 52 is locked onto the upper arm 16 by the forked member 48.

Once the forked member 48 of the facing device 44 is locked in place in the slots 56 of the tubular member 52, operation of the facing device 42 is the same as disclosed above with regard to the facing device 40. I contemplate that the facing device 42 may be fabricated from a variety of materials, including plastics and metals. The facing device 44 may be provided as a separable item for installation onto a scanning hook, or may alternatively be supplied as part of a scanning hook apparatus including the facing device 42 integrally joined to a scanning hook. The forked member 48 and tubular member 52 may alternatively be inseparably joined together in some embodiments of my invention.

In some embodiments of my invention, it may be desired that a display apparatus incorporating my invention include a return element operatively attached between the facing device and the scanning hook, for providing a force for returning the facing device to an initial stowed position along the upper arm of the scanning hook. The return element may take a virtually unlimited number of forms, depending upon the configuration of the particular embodiment of my invention being utilized.

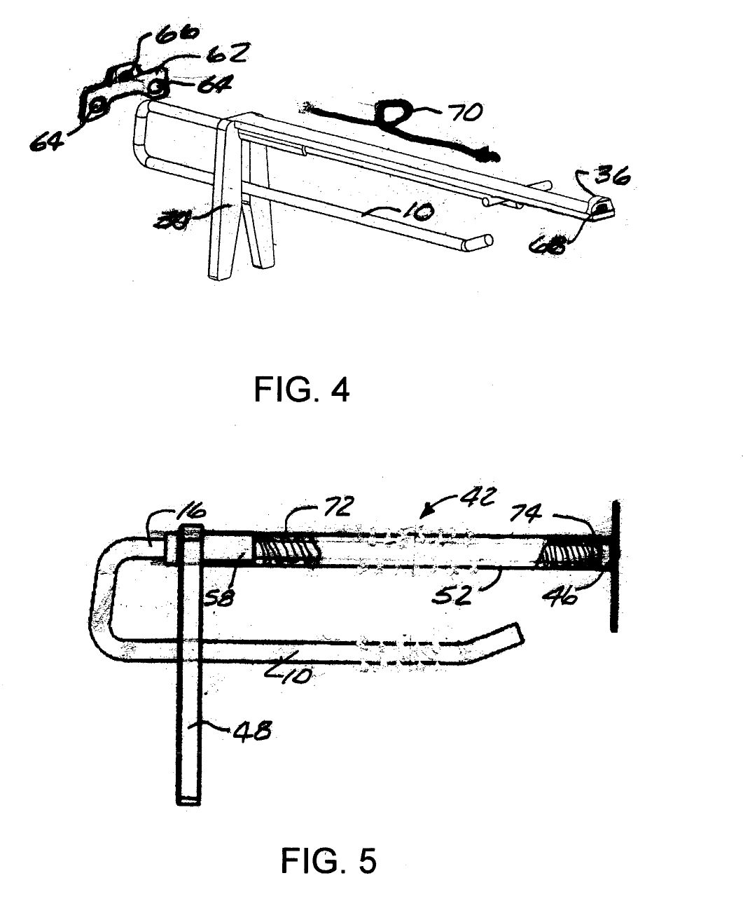

For example, as shown in FIG. 4, for an embodiment of my invention similar to the one shown in FIGS. 2a-e, the return element may include a retainer 62 and an elastomeric band 70. The retainer 62 includes holes 64 for engaging the horns of the mounting bracket 22, and a hole 66 for passage there through of one end of the elastomeric band 70. The grip element 36 of the facing element 30 also includes a through-hole 68, for passage there through of the other end of the elastomeric band 70. Once the ends of the elastomeric band 70 are passed through the holes 66, 68 in the retainer 62 and the grip element 36, the ends are knotted or otherwise adapted so that they cannot be pulled back through the holes 66, 68.

As shown in FIG. 5, for an embodiment of my invention as shown in FIGS. 3a-d, the return element may include a compression spring 72 operatively disposed within the tubular member 52, about the upper arm of the scanning hook 10, between the ball end 46 of the upper arm 16 and the locking channel portion 58 of the forked element 48, for providing a force urging the facing device 42 to return to an initial stowed position along the upper arm 16. The outer end of the spring 72 may be formed to snap over and engage the ball end 46, so that the spring 72 is retained on the upper arm 16. Alternatively, a retaining element 74 may be snapped over the upper arm 16 between the spring 72 and the ball end 46, for retaining the spring 72 on the upper arm 16 within the tubular member 52.

While the embodiments of my invention disclosed herein are presently considered to be preferred, various changes and modifications can be made without departing from the spirit and scope of the invention.

I claim:

1. A display apparatus, comprising:
a scanning hook having a lower arm for supporting one or more product packages, and an upper arm for supporting a label at an outer distal end of the upper arm; and
a facing device attached to the upper arm for sliding movement there along and adapted to be gripped adjacent the outer distal end of the upper arm regardless of the position of the facing device along the upper arm, for facing product packages supported on the lower arm of the scanning hook.

2. The display apparatus of claim 1 further including a return element operatively attached between the facing device and the scanning hook providing a force for returning the facing device to an initial stowed position along the upper arm of the scanning hook.

3. The display apparatus of claim 1 wherein the display apparatus further includes a mounting bracket adapted for attaching the scanning hook to a panel.

4. The display apparatus of claim 3 wherein the upper and lower arms of the scanning hook are connected by a U-shaped portion of the scanning hook for attachment to the mounting bracket.

5. The display apparatus of claim 1 wherein the upper arm includes an outer distal end thereof adapted for attachment of a label holder.

6. The display apparatus of claim 5 including a label holder.

7. The display apparatus of claim 1 wherein the facing device includes a downward extending element for engaging a rear surface of a product package on the lower arm; and
a pulling member extending from the downward extending element along the upper arm and having a grip element at a distal end of the pulling member, for gripping and moving the facing device along the upper arm.

8. The display apparatus of claim 7 further comprising:
a mounting bracket adapted for attaching the scanning hook to a panel;
an extensible return element operatively attached between the grip element of the facing device and the mounting bracket for providing a force for returning the facing device to an initial stowed position along the upper arm of the scanning hook.

9. The display apparatus of claim 7 wherein the pulling member includes a snap-fit channel element for attaching the facing device onto the upper arm.

10. The display apparatus of claim 7 wherein the downward extending element of the facing device includes a forked element extending downward past the lower arm when the facing element is attached to the upper arm.

11. The display apparatus of claim 7 wherein the grip element is a label holder.

12. The display apparatus of claim 7 wherein:
the upper arm defines a cross section of the upper arm, terminating at the distal end thereof in a head having a cross section of the head that is larger than the cross section of the upper arm; and
the facing device is formed of two pieces, a forked element, and a pulling element;
the pulling element including an elongated tubular member and a label holder;
the tubular member having an inner open cross section larger than the cross section of the head, such that the tubular element can slide over the head and upper arm of the scanning hook;
the label holder integrally joined to the outer end of the tubular member and serving a dual function as the grip element of the facing device;
the tubular member also defining a pair of oppositely opening slots adjacent the open end of the tubular member, for receipt of a locking channel portion of the forked element, the locking channel portion defining an inner cross section of the locking channel portion of the forked element that is smaller than the cross section of the head, but sufficiently larger than the cross section of the upper arm, such that once the locking channel portion is snapped into place in the slots of the tubular member around the upper arm, for locking the tubular member onto the upper arm with the forked member.

13. The display apparatus of claim 12 further comprising a compression spring element operatively disposed within the tubular member between the head and the locking channel portion of the forked element for providing a force urging the facing device to return to an initial stowed position along the upper arm.

14. A facing device for attachment to an upper arm of a scanning hook for facing product packages suspended on a lower arm of the scanning hook, the facing device comprising:
a downward extending element for engaging a rear surface of a product package on the lower arm of the scanning hook; and
a pulling member extending from the downward extending element along the upper arm and having a grip element at a distal end of the pulling member, for gripping and moving the facing device along the upper arm.

15. The facing device of claim 14 further including a return element adapted for operative attachment between the facing device and the scanning hook providing a force for returning the facing device to an initial stowed position along the upper arm of the scanning hook.

16. The facing device of claim 14 wherein the pulling member includes a snap-fit channel element for attaching the facing device onto the upper arm.

17. The facing device of claim 14 wherein the downward extending element includes a forked element extending downward past the lower arm when the facing device is attached to the upper arm.

18. The facing device of claim 14 wherein the grip element is a label holder.

19. The facing device of claim 14 wherein:
the upper arm of the scanning hook defines a cross section of the upper arm, terminating at the distal end thereof in a head having a cross section of the head that is larger than the cross section of the upper arm; and
the facing device is formed of two pieces, a forked element, and a pulling element;
the pulling element including an elongated tubular member and a label holder;
the tubular member having an inner open cross section larger than the cross section of the head, such that the tubular element can slide over the head and upper arm of the scanning hook;
the label holder integrally joined to the outer end of the tubular member for serving a dual function as the grip element of the facing device;
the tubular member also defining a pair of oppositely opening slots adjacent the open end of the tubular member, for receipt of a locking channel portion of the forked element, the locking channel portion defining an inner cross section of the locking channel portion of the forked element that is smaller than the cross section of the head, but sufficiently larger than the cross section of the upper arm, such that once the locking channel portion is snapped into place in the slots of the tubular member around the upper arm, for locking the tubular member onto the upper arm with the forked member.

20. The display apparatus of claim 19 further comprising a compression spring element adapted to be operatively disposed within the tubular member between the head of the upper arm of the scanning hook and the locking channel portion of the forked element for providing a force urging the facing device to return to an initial stowed position along the upper arm.

21. A method for facing one or more product packages suspended from the lower arm of a scanning hook, the method comprising comprising;
attaching a facing device to the upper arm for sliding movement there along and adapted to be gripped adjacent the outer distal end of the upper arm regardless of the position of the facing device along the upper arm, for facing product packages supported on the lower arm of the scanning hook.

22. The method of claim 21 further comprising operatively attaching a return element between the facing device and the scanning hook for providing a force for urging the facing device to return to an initial stowed position along the upper arm of the scanning hook.

23. The method of claim 21 further comprising grasping the facing device adjacent the outer distal end of the upper arm and pulling the facing device forward toward the outer distal end of the upper arm.

24. The method of claim 21 further comprising:
providing a downward extending element on the facing device for engaging a rear surface of a product package on the lower arm, and a pulling member extending from the downward extending element along the upper arm and having a grip element at a distal end of the pulling member, for gripping and moving the facing device along the upper arm; and
pulling the product packages forward on the lower arm by grasping and pulling on the grip element of the facing device.

25. The method of claim 24 further comprising pushing the facing device back along the upper arm to a stowed position where the grip element is adjacent the outer distal end of the upper arm.

26. The method of claim 24 further comprising:
sequentially hanging product packages on the lower arm of the scanning hook with the rear surface of one package in contact with the downward extending element of the facing device.
